(19) United States
(12) Patent Application Publication
(10) Pub. No.: US 2026/0159256 A1
(43) Pub. Date: Jun. 11, 2026

(54) SYSTEM AND METHOD SUITABLE FOR CONTROLLING LANDING OF A LANDER TO A DESIRED LANDING LOCATION UNDER NAVIGATIONAL UNCERTAINTY

(71) Applicant: Mitsubishi Electric Research Laboratories, Inc., CAMBRIDGE, MA (US)

(72) Inventors: Yana Lishkova, Oxford (GB); Abraham Vinod, Braintree, MA (US); Stefano Di Cairano, Newton, MA (US); Avishai Weiss, Boston, MA (US)

(73) Assignee: Mitsubishi Electric Research Laboratories, Inc., CAMBRIDGE, MA (US)

(21) Appl. No.: 18/975,196

(22) Filed: Dec. 10, 2024

(51) Int. Cl. B64G 1/24; B64G 1/10

(52) U.S. Cl. CPC B64G 1/242; B64G 1/1071

(57) ABSTRACT

The present disclosure provides a lander configured for powered descent landing with uncertainty in a current state of the lander. The lander comprises a memory configured to store a list of desired landing locations on a landing surface, and a plurality of controllable sets. The lander further comprises a motion planner configured to (1) select a controllable set from the plurality of controllable sets based on a current amount of fuel in the lander and a desired time of descent to the landing surface; (2) shift the selected controllable set along a horizontal axis to place its hover point above a landing location selected from the list of desired landing locations; (3) check if a current state of the lander lies within the selected controllable set, and generate a trajectory from the current state of the lander to the hover point of the shifted controllable set.

### TECHNICAL FIELD

The present disclosure relates generally to control systems, and more specifically to a system and a method suitable for controlling landing of a lander to a desired landing location under navigational uncertainty.

### BACKGROUND

In space exploration, a key challenge lies in ensuring a successful and precise landing of a lander on a landing surface, such as a landing surface of the moon. A powered descent guidance (PDG) system is employed to control the lander to safely reach a target landing location on the landing surface. This process involves continuous estimation of the lander's state, which includes its position, velocity, and attitude relative to the landing surface.

A critical aspect of the PDG system is an ability to estimate the lander's state accurately while landing the lander to the target landing location. The estimation of the lander state, however, is challenging due to uncertainty in both measurements used to determine the lander state and dynamic lunar environment in which the lander operates. For instance, methods for the estimation of the lander state rely on a combination of on-board sensors, such as altimeters, accelerometers, gyroscopes, and star trackers, along with on-board computational algorithms to provide estimates of the lander's position and velocity.

However, limited accuracy and noise associated with the on-board sensors, compounded by the dynamic lunar environment, introduce uncertainty in the estimation of the lander state. Such uncertainty leads to errors in tracking of a descent trajectory to the target landing location, potentially resulting in missed landing locations or, in the worst case, a failure to land safely.

Therefore, there is a need for a system and a method for controlling the landing of the lander to the target landing location in presence of the uncertainty.

### SUMMARY

It is an objective of some embodiments to provide a system and a method for performing powered descent landing of a lander to a desired landing location on a landing surface accurately and safely, under navigational uncertainty. It is also an objective of some embodiments to shift the desired landing location to another landing location, upon detection of a hazard at the desired landing location during the powered descent landing. Further, it an objective of some embodiments to control the powered descent landing of the lander to the other landing location such that the lander lands at the other landing location accurately and safely under the navigational uncertainty.

The lander is configured to perform the powered descent landing to land at the desired landing location on the landing surface. In an embodiment, the lander is a spacecraft and the landing surface corresponds to a surface of a celestial body. For instance, the landing surface corresponds to a surface of moon. To land the lander at the desired landing location, a controllable set for the lander is obtained. The controllable set includes a set of states of the lander from which the lander can be driven to the desired landing location. The state of the lander includes one or more of a location of the lander and a velocity of the lander. Given the controllable set and a current state of the lander, a trajectory is determined for the lander for landing at the desired landing location.

However, due to the navigational uncertainty, i.e., uncertainty in estimation of the location and the velocity of the lander, the lander may not land accurately at the desired landing location. Further, even if the lander lands at the desired landing location, the lander may not land safely, e.g., the lander lands at the desired landing location with a high velocity and crashes. Even more so, due to the navigational uncertainty, the lander neither lands accurately at the desired landing location nor lands safely at the desired landing location.

Some embodiments are based on the realization that, to mitigate such a problem, instead of navigating the lander to the desired landing location, the lander can first be navigated to a hover point that is located at a predetermined distance above the desired landing location. To this end, a controllable set that characterizes a set of noisy state estimates of the lander from which the lander can be driven to the hover point with a user specified probability, is obtained. The hover point is a closest point to the desired landing location that can be reached with the user specified probability.

Based on this controllable set and the current state of the lander, a trajectory connecting from the current state of the lander to the hover point is determined. The lander traverses the trajectory to reach the hover point. Further, a feedback controller or any other controller associated with the lander is configured to determine a trajectory that connects the hover point to the desired landing location. The lander traverses the trajectory that connects the hover point to the desired landing location to land at the desired landing location.

Since the lander is first navigated to the hover point which is the closest point to the desired landing location that is reached with the user specified probability, and then to the desired landing location, the aforesaid effects of the navigational uncertainty on the landing of the lander is minimized. Consequently, the lander lands at the desired landing location accurately and safely.

Some embodiments are based on the recognition that during the powered descent landing, the lander scans for hazards at the desired landing location. The hazards, for example, include uneven surface and craters that are unfavorable for landing the lander. In a case where the hazard is detected at the desired landing location, the desired landing location is to be changed to avoid unsafe landing at the desired landing location.

To this end, in some embodiments, upon the detection of the hazard at the desired landing location, the controllable set is shifted to a maximum distance along a horizontal axis while maintaining the current state of the lander within the controllable set, and further the hover point of the shifted controllable set is placed at the predetermined distance above another desired landing location. Further, a trajectory connecting from the current state of the lander to the hover point of the shifted controllable set placed at the predetermined distance above another desired landing location, is determined. The lander traverses this trajectory to navigate to the hover point of the shifted controllable set.

Accordingly, one embodiment discloses a lander configured for powered descent landing with uncertainty in a current state of the lander. The lander comprises a memory configured to store a list of desired landing locations on a landing surface, and a plurality of controllable sets determined for different amounts of fuel remaining in the lander and a desired time of descent to the landing surface, wherein each controllable set is a polytope defining a volume of states symmetric around a vertical axis perpendicular to the landing surface with a hover point located on the vertical axis at a predetermined distance above the landing surface as a vertex, and wherein each state includes a location and a velocity of the lander. The lander further comprises a motion planner configured to (1) select a controllable set from the plurality of controllable sets based on a current amount of fuel remaining in the lander and the desired time of descent; (2) shift the selected controllable set along a horizontal axis to place the hover point above a landing location selected from the list of desired landing locations; (3) check if a current state of the lander lies within the selected controllable set, and generate a trajectory from the current state of the lander to the hover point of the shifted controllable set; else (4) select another landing location from the list of desired landing location. The lander further comprises a controller configured to control the lander according to the trajectory to navigate the lander to the hover point.

Accordingly, another embodiment discloses a method for performing powered descent landing with uncertainty in a current state of a lander. The method uses a memory configured to store a list of desired landing locations on a landing surface, and a plurality of controllable sets determined for different amounts of fuel remaining in the lander and a desired time of descent to the landing surface, wherein each controllable set is a polytope defining a volume of states symmetric around a vertical axis perpendicular to the landing surface with a hover point located on the vertical axis at a predetermined distance above the landing surface as a vertex, and wherein each state includes a location and a velocity of the lander. The method comprises selecting a controllable set from the plurality of controllable sets based on a current amount of fuel remaining in the lander and the desired time of descent; shifting the selected controllable set along a horizontal axis to place the hover point above a landing location selected from the list of desired landing locations; checking if a current state of the lander lies within the selected controllable set; generating a trajectory from the current state of the lander to the hover point of the shifted controllable set if the current state of the lander lies within the selected controllable set; and controlling the lander according to the trajectory to navigate the lander to the hover point.

Accordingly, yet another embodiment discloses a non-transitory computer-readable storage medium embodied thereon a program executable by a processor for performing a method for performing powered descent landing with uncertainty in a current state of a lander, the storage medium stores a list of desired landing locations on a landing surface, and a plurality of controllable sets determined for different amounts of fuel remaining in the lander and a desired time of descent to the landing surface, wherein each controllable set is a polytope defining a volume of states symmetric around a vertical axis perpendicular to the landing surface with a hover point located on the vertical axis at a predetermined distance above the landing surface as a vertex, and wherein each state includes a location and a velocity of the lander. The method comprises selecting a controllable set from the plurality of controllable sets based on a current amount of fuel remaining in the lander and the desired time of descent; shifting the selected controllable set along a horizontal axis to place the hover point above a landing location selected from the list of desired landing locations; checking if a current state of the lander lies within the selected controllable set; generating a trajectory from the current state of the lander to the hover point of the shifted controllable set if the current state of the lander lies within the selected controllable set; and controlling the lander according to the trajectory to navigate the lander to the hover point.

### BRIEF DESCRIPTION OF THE DRAWINGS

The presently disclosed embodiments will be further explained with reference to the attached drawings. The drawings shown are not necessarily to scale, with emphasis instead generally being placed upon illustrating the principles of the presently disclosed embodiments.

FIG. 1A illustrates principles used by some embodiments of the present disclosure for performing powered descent landing of a lander.

FIG. 1B illustrates the lander for performing the powered descent landing to a landing location, according to some embodiments of the present disclosure.

FIG. 1C illustrates a controllable set of a plurality of controllable sets, according to some embodiments of the present disclosure.

FIG. 1D shows a block diagram of steps executed to perform the powered descent landing, according to some embodiments of the present disclosure.

FIG. 2A illustrates shifting of a selected controllable set along a horizontal axis, according to some embodiments of the present disclosure.

FIG. 2B illustrates shifting the selected controllable set in a horizontal plane, according to some embodiments of the present disclosure.

FIG. 3 illustrates that a hover point of a stochastic controllable set is a center of an ellipsoid, according to an embodiment of the present disclosure.

FIG. 4A illustrates multiple shifted copies of the selected controllable set, according to some embodiments of the present disclosure.

FIG. 4B illustrates changing of a desired landing location upon detection of a hazard at the desired landing location, according to some embodiments of the present disclosure.

FIG. 5A illustrates shifting of the selected controllable set upon the detection of the hazard, according to some embodiments of the present disclosure.

FIG. 5B illustrates shifting of the selected controllable set upon the detection of the hazard, according to some other embodiments of the present disclosure.

FIG. 5C illustrates a trajectory from a current state of the lander to a hover point of the selected controllable set shifted to a maximum distance, according to some other embodiments of the present disclosure.

FIG. 6A illustrates an algorithm for determining the stochastic controllable set, according to an embodiment of the present disclosure.

FIG. 6B shows a schematic of computation of the stochastic controllable set, according to an embodiment of the present disclosure.

FIG. 7 is a schematic illustrating by non-limiting example a computing apparatus for implementing the methods and the systems of the present disclosure.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, apparatuses and methods are shown in block diagram form only in order to avoid obscuring the present disclosure.

As used in this specification and claims, the terms “for example,” “for instance,” and “such as,” and the verbs “comprising,” “having,” “including,” and their other verb forms, when used in conjunction with a listing of one or more components or other items, are each to be construed as open ended, meaning that that the listing is not to be considered as excluding other, additional components or items. The term “based on” means at least partially based on. Further, it is to be understood that the phraseology and terminology employed herein are for the purpose of the description and should not be regarded as limiting. Any heading utilized within this description is for convenience only and has no legal or limiting effect.

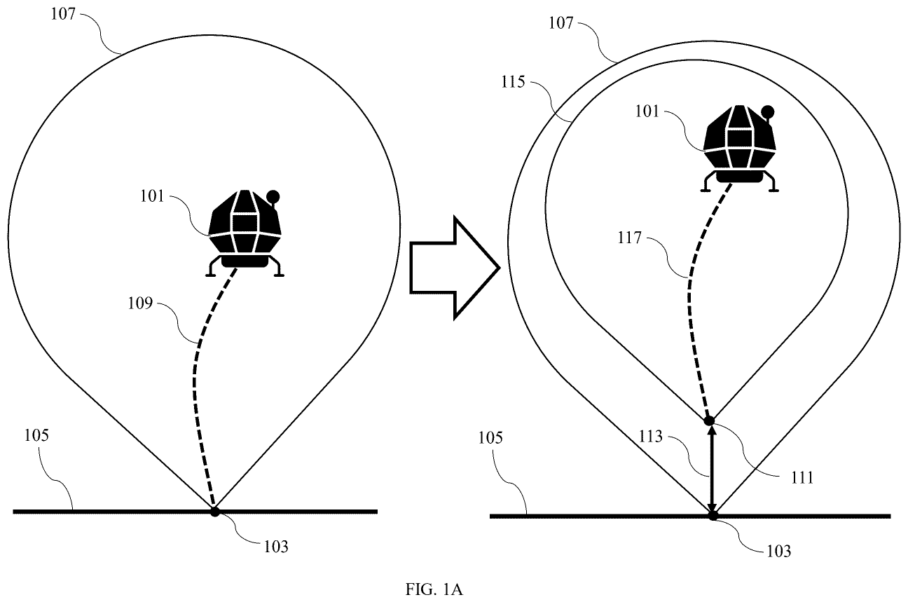

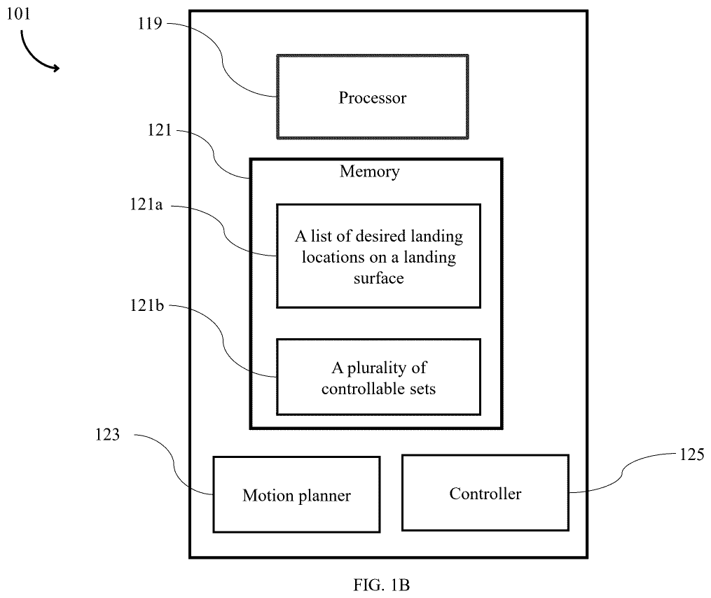

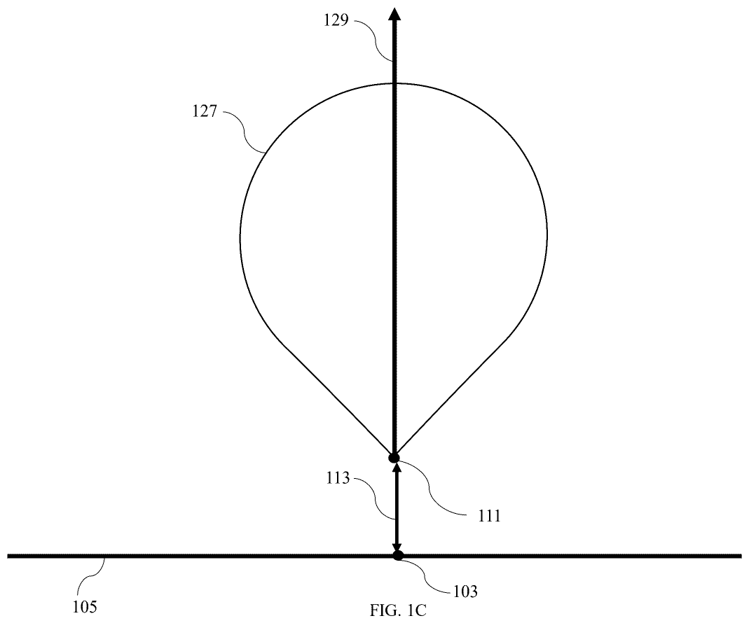

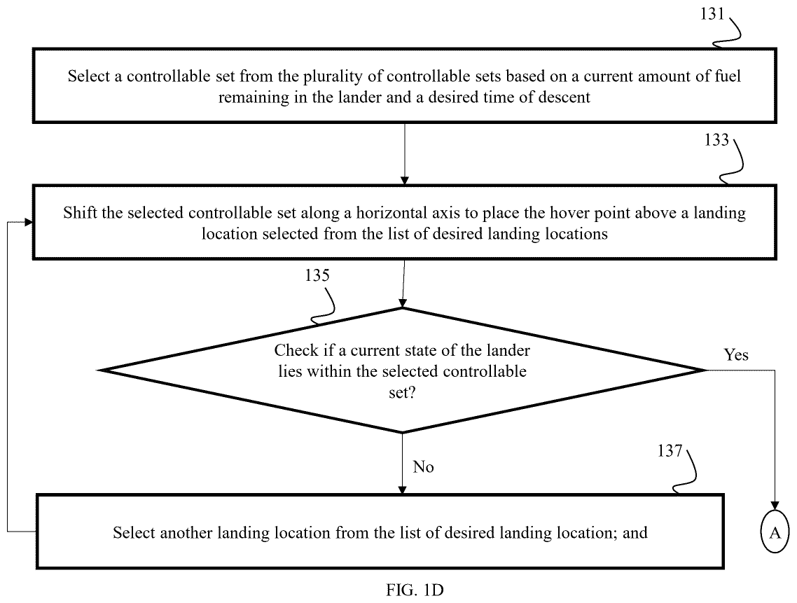

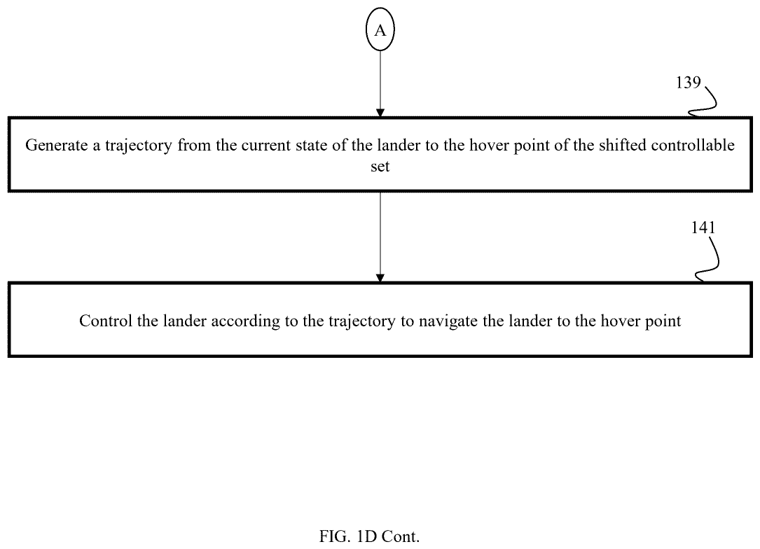

FIG. 1A illustrates principles used by some embodiments of the present disclosure for performing powered descent landing of a lander 101. The lander 101 is configured to perform the powered descent landing to land at a landing location 103 on a landing surface 105. In an embodiment, the lander 101 is a spacecraft and the landing surface 105 corresponds to a surface of a celestial body. For instance, the landing surface 105 corresponds to a surface of moon.

To land the lander 101 at the landing location 103, a controllable set 107 for the lander 101 is obtained. The controllable set 107 includes a set of states of the lander 101 from which the lander 101 can be driven to the landing location 103. The state of the lander 101 includes one or more of a location of the lander 101 and a velocity of the lander 101. Given the controllable set 107 and a current state of the lander 101, a trajectory 109 is determined for the lander 101 for landing at the landing location 103.

However, due to navigational uncertainty, i.e., uncertainty in estimation of the location and the velocity of the lander 101, the lander 101 may not land accurately at the landing location 103. Further, even if the lander 101 lands at the landing location 103, the lander 101 may not land safely, e.g., the lander 101 lands at the landing location 103 with a high velocity and crashes. Even more so, due to the navigational uncertainty, the lander 101 neither lands accurately at the landing location 103 nor lands safely at the landing location 103.

Some embodiments are based on the realization that, to mitigate such a problem, instead of navigating the lander 101 to the landing location 103, the lander 101 can first be navigated to a hover point 111 that is located at a predetermined distance 113 above the landing location 103. To this end, a controllable set 115 that characterizes a set of noisy state estimates of the lander 101 from which the lander 101 can be driven to the hover point 111 with a user specified probability, is obtained. In an embodiment, the controllable set 115 is obtained based on a constraint tightened modification of computations used to compute the controllable set 107. The hover point 111 is a closest point to the landing location 103 that can be reached with the user specified probability.

Based on the controllable set 115 and the current state of the lander 101, a trajectory 117 connecting from the current state of the lander 101 to the hover point 111 is determined. The lander 101 traverses the trajectory 117 to reach the hover point 111. Further, a feedback controller or any other controller associated with the lander 101 is configured to determine a trajectory that connects the hover point 111 to the landing location 103. The lander 101 traverses the trajectory to land at the landing location 103.

Since the lander 101 is first navigated to the hover point 111 which is the closest point to the landing location 103 that is reached with the user specified probability, and then to the landing location 103, the aforesaid effects of the navigational uncertainty on the landing of the lander 101 is minimized. Consequently, the lander 101 lands at the landing location 103 accurately and safely.

FIG. 1B illustrates the lander 101 for performing the powered descent landing to the landing location 103, according to some embodiments of the present disclosure. The lander 101 includes a processor 119, a memory 121, a motion planner 123, and a controller 125. The processor 119 may be a single core processor, a multi-core processor, a computing cluster, or any number of other configurations. The memory 121 may include random access memory (RAM), read only memory (ROM), flash memory, or any other suitable memory systems. Additionally, in some embodiments, the memory 121 may be implemented using a hard drive, an optical drive, a thumb drive, an array of drives, or any combinations thereof. In some embodiments, the motion planner 123 and the controller 125 are modules of the lander 101 and are executed by the processor 119.

The memory 121 includes a list 121a of desired landing locations on the landing surface 105, and a plurality of controllable sets 121b. The plurality of controllable sets 121b are determined for different amounts of fuel remaining in the lander 101 and a desired time of descent to the landing surface 105. The plurality of controllable sets 121b are determined offline, i.e., in advance, and stored in the memory 121.

FIG. 1C illustrates a controllable set 127 of the plurality of controllable sets 121b, according to some embodiments of the present disclosure. The controllable set 127 is similar to the controllable set 115 described above in FIG. 1A. The controllable set 127 is a polytope defining a volume of states symmetric around a vertical axis 129 perpendicular to the landing surface 105 with the hover point 111 located on the vertical axis 129 at the predetermined distance 113 above the landing surface 105 as a vertex.

The motion planner 123 and the controller 125 are configured to perform the powered descent to the landing location 103 using the plurality of controllable sets 121b, as described below in FIG. 1D.

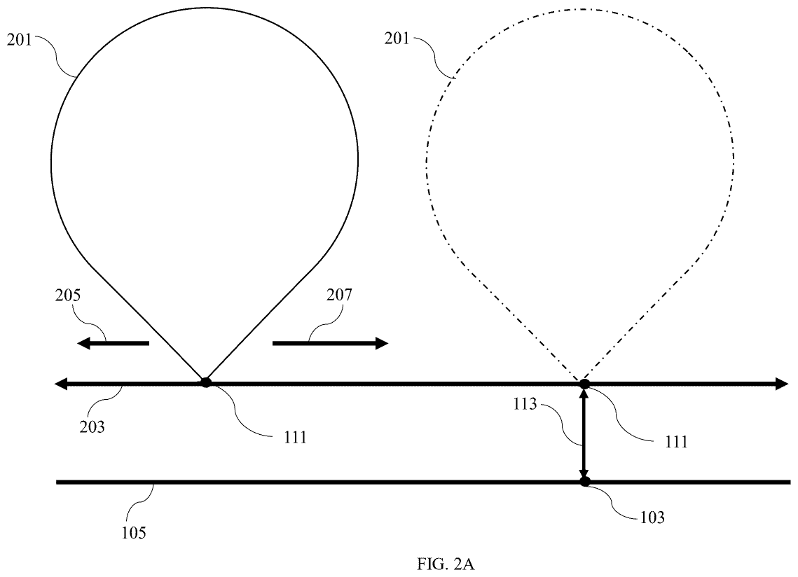

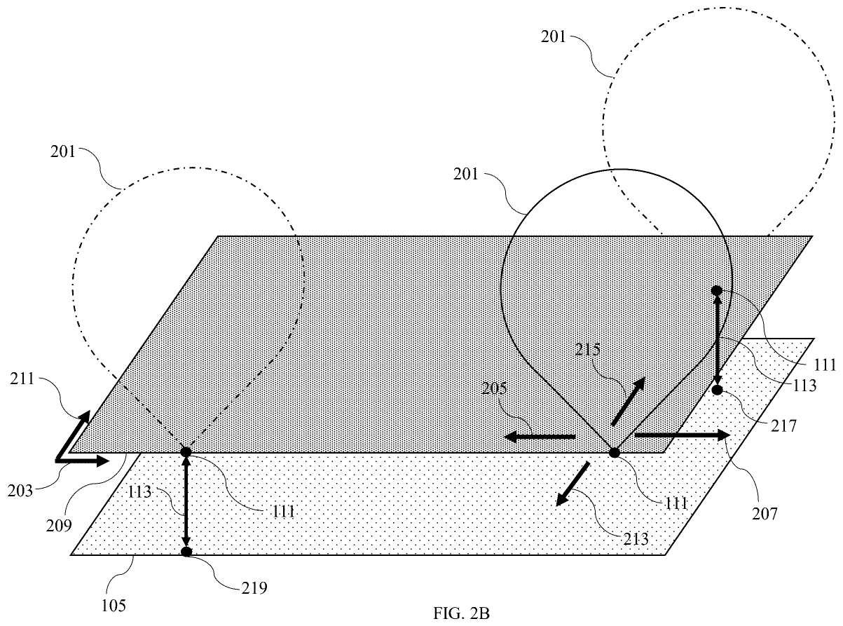

FIG. 1D shows a block diagram of steps executed to perform the powered descent landing, according to some embodiments of the present disclosure. At block 131, the motion planner 123 is configured to select a controllable set from the plurality of controllable sets 121b based on a current amount of fuel remaining in the lander and the desired time of descent. At block 133, the motion planner 123 is configured to shift the selected controllable set along a horizontal axis to place the hover point 111 above a landing location (e.g., the landing location 103) selected from the list 121a of desired landing locations. The shifting of the selected controllable set along the horizontal axis is explained in detail in FIG. 2A.

At block 135, the motion planner 123 is configured to check if the current state of the lander 101 lies within the selected controllable set. If the current state of the lander 101 does not lie within the selected controllable set, then, at block 137, the motion planner 123 is configured to select another landing location from the list 121a of desired landing location and further execute step of the block 133.

If the current state of the lander 101 lies within the selected controllable set, then, at block 139, the motion planner 123 is configured to generate a trajectory from the current state of the lander to the hover point 111 of the shifted controllable set. Further, at block 141, the controller 125 is configured to control the lander according to the trajectory to navigate the lander to the hover point 111.

FIG. 2A illustrates shifting of a selected controllable set 201 along a horizontal axis 203, according to some embodiments of the present disclosure. The motion planner 123 is configured to shift the selected controllable set 201 in a direction 205 or a direction 207 along the horizontal axis 203 to place the hover point 111 of the selected controllable set 201 above the landing location 103. For instance, the motion planner 123 shifts the selected controllable set 201 in the direction 207 along the horizontal axis 203 to place the hover point 111 above the landing location 103. The hover point 111 of the selected controllable set 201 is placed above the landing location 103 at the predetermined distance 113 above the landing location 103. The predetermined distance 113 above the landing location 103 remains fixed.

In some embodiments, the motion planner 123 is configured to shift the selected controllable set 201 in a horizontal plane to place the selected controllable set 201 above the landing location 103.

FIG. 2B illustrates shifting the selected controllable set 201 in a horizontal plane 209, according to some embodiments of the present disclosure. The horizontal plane 209 is defined by the horizontal axis 203 and an axis 211. The motion planner 123 is configured to shift the selected controllable set 201 in a direction 213 or a direction 215 along the axis 211 to place the hover point above a desired landing location. For instance, the motion planner 123 shifts the selected controllable set 201 in the direction 215 along the axis 211 to place the hover point 111 above a desired landing location 217. The hover point 111 of the selected controllable set 201 is placed above the desired landing location 217 at the predetermined distance 113 above the desired landing location 217.

Likewise, the motion planner 123 is configured to shift the selected controllable set 201 in the direction 205 or the direction 207 along the horizontal axis 203 to place the hover point 111 above a desired landing location. For instance, the motion planner 123 shifts the selected controllable set 201 in the direction 205 along the horizontal axis 203 to place the hover point 111 above a desired landing location 219. The hover point 111 of the selected controllable set 201 is placed above the desired landing location 219 at the predetermined distance 113 above the desired landing location 219 on the landing surface 105.

In an embodiment, the predetermined distance 113 of the hover point 111 above the landing surface 105 is a function of stochastic guarantees of a chance constraint imposed on the powered descent landing. For instance, the lander 101 is limited by physical and operational constraints, such as, a mass constraint that requires mass of the lander 101 to lie between a dry mass m_{d} and a wet mass m_{w}=m_{d}+m_{f}, where m_{f} is an initial mass of the remaining fuel, a thrust constraint that requires thrust of the lander 101 to bounded from above and below with known constants ρ₁,ρ₂, a glideslope constraint with a glideslope angle relative to a landing site, such that the lander 101 avoids crashing into nearby terrain, and a velocity constraint that sets a maximum velocity for the lander 101. Such physical and operational constraints are reformulated into chance constraints and imposed on the power descent landing. The predetermined distance 113 of the hover point 111 above the landing surface 105 is a function of stochastic guarantees of the chance constraints imposed on the powered descent landing.

In some embodiments, each of the plurality of controllable sets 121b is a stochastic controllable set. The stochastic controllable set is a set of current state estimates of the lander 101 from which the lander 101 can be driven to a hover point associated with the stochastic controllable set with the user specified probability for an amount of remaining fuel and the desired time of descent.

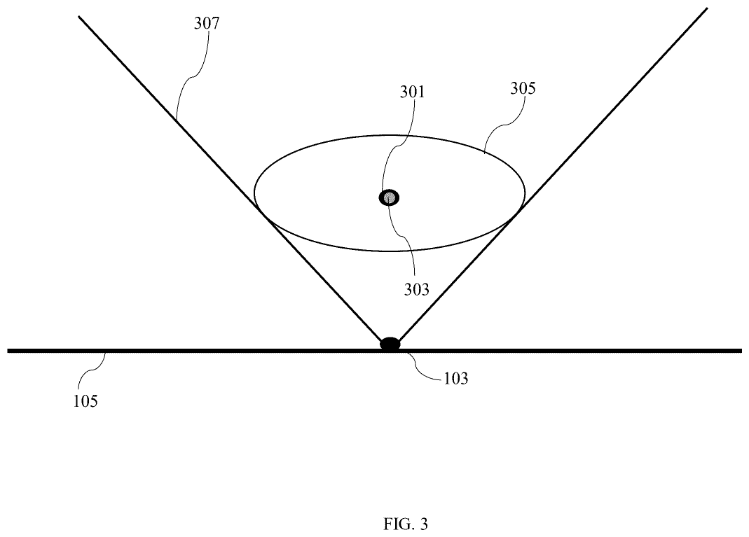

In an embodiment, the hover point of the stochastic controllable set is a center of an ellipsoid. FIG. 3 illustrates that a hover point 301 of the stochastic controllable set is a center 303 of an ellipsoid 305, according to an embodiment of the present disclosure. The ellipsoid 305 is a function of the stochastic guarantees of the chance constraints imposed on the powered descent landing. The center 303 of the ellipsoid 305 is the closest point to the landing location 103 on the landing surface 105 such that the ellipsoid 305 is entirely contained within an area defined by state constraints, e.g. a glideslope constraint 307.

In some embodiments, the motion planner 123 is configured to determine multiple shifted copies of the selected controllable set 201 and place each of them on a different landing location.

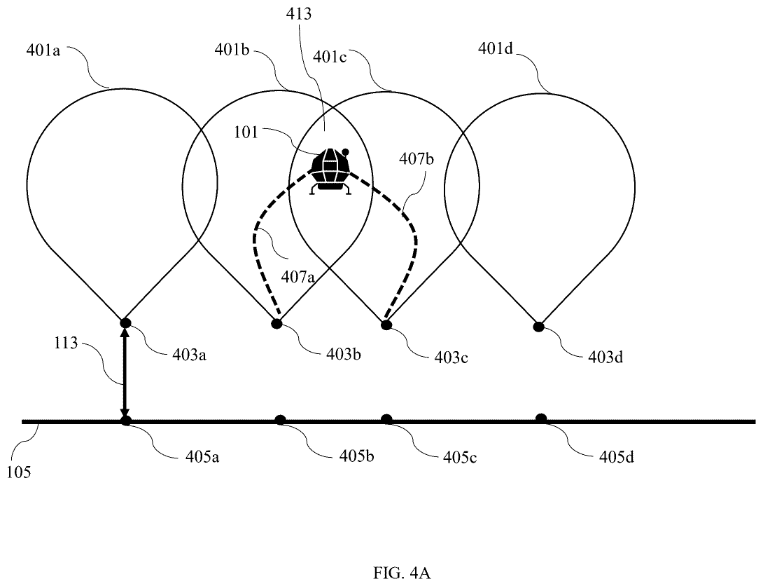

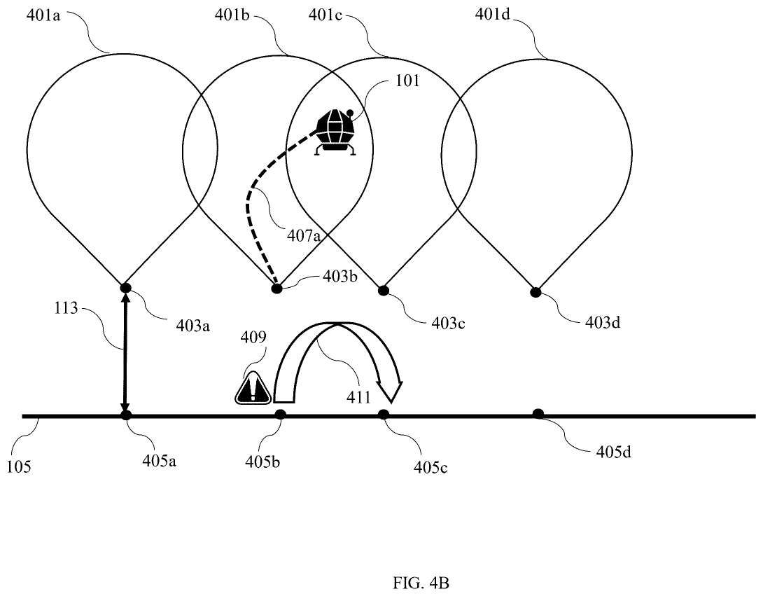

FIG. 4A illustrates multiple shifted copies 401a-401d of the selected controllable set 201, according to some embodiments of the present disclosure. The motion planner 123 is configured to place a hover point 403a of the shifted copy 401a of the selected controllable set 201 at the predetermined distance 113 above a landing location 405a. Likewise, the motion planner 123 places a hover point 403b of the shifted copy 401b of the selected controllable set 201 at the predetermined distance 113 above a landing location 405b. Likewise, the motion planner 123 places a hover point 403c of the shifted copy 401c of the selected controllable set 201 at the predetermined distance 113 above a landing location 405c. Likewise, the motion planner 123 places a hover point 403d of the shifted copy 401d of the selected controllable set 201 at the predetermined distance 113 above a landing location 405d. The different landing locations 405a-405d are selected from the list 121a of desired locations stored in the memory 121.

Further, the motion planner 123 maintains the current state of the lander 101 within an intersection of the multiple shifted copies 401a-401d of the selected controllable set 201. The motion planner 123 is configured to determine a trajectory from the current state of the lander 101 to a hover point of a shifted copy of the selected controllable set located above a desired landing location selected from the different landing locations 405a-405d, while prioritizing maintaining the trajectory within an intersection of two or more shifted copies of the multiple shifted copies of the selected controllable set. For instance, the lander 101 is within an intersection 413 of the shifted copies 410b and 401c and is desired to land at the desired landing location 405b, the motion planner 123 is configured to determine a trajectory 407a from the current state of the lander 101 within the intersection 413 to the hover point 403b of the shifted copy 401b of the selected controllable set 201 located above the desired landing location 405b. Alternatively, the motion planner 123 is configured to determine a trajectory 407b from the current state of the lander 101 within the intersection 413 to the hover point 403c of the shifted copy 401c of the selected controllable set 201 located above the desired landing location 405c.

Some embodiments are based on the recognition that during the powered descent landing, the lander 101 scans for hazards at the landing location (e.g., the desired landing location 405b). The hazards, for example, include uneven surface and craters that are unfavorable for landing the lander 101. In a case where the hazard is detected at the desired landing location 405b, the desired landing location 405b is to be changed to avoid unsafe landing at the desired landing location 405b.

FIG. 4B illustrates changing of the desired landing location 405b upon the detection of the hazard at the desired landing location 405b, according to some embodiments of the present disclosure. Upon detection of a hazard 409 at the desired landing location 405b, the motion planner 123 is configured change the desired landing location 405b to a different landing location. For example, upon the detection of the hazard 409 at the desired landing location 405b, the motion planner 123 changes 411 from the desired landing location 405b below the hover point 403b of the shifted copy 401b of the selected controllable set 201 to the landing location 405c below the hover point 403c of the shifted copy 401c of the selected controllable set 201. Further, the motion planner 123 determines a trajectory from the current state of the lander 101 to the hover point 403c.

In some other embodiments, the selected controllable set 201 is shifted upon the detection of the hazards.

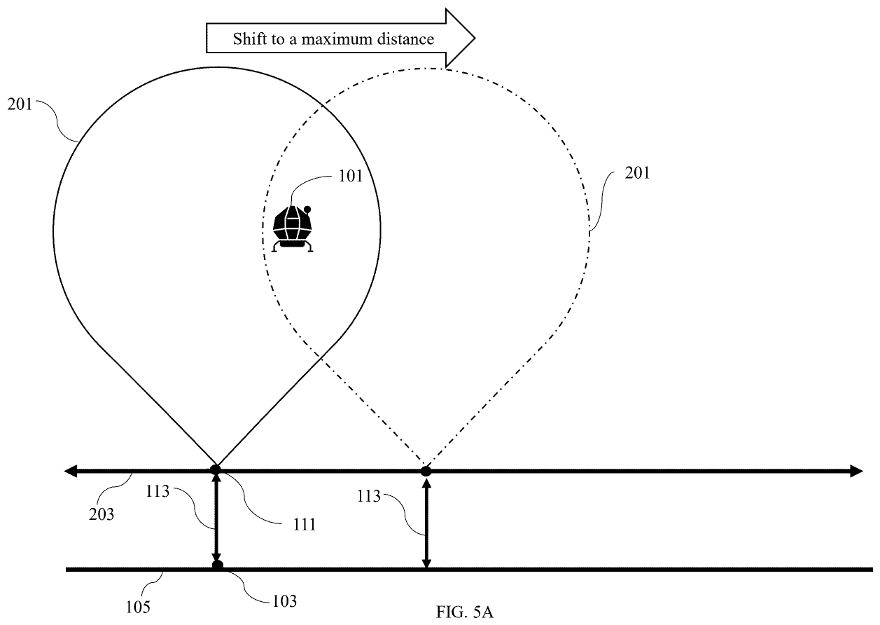

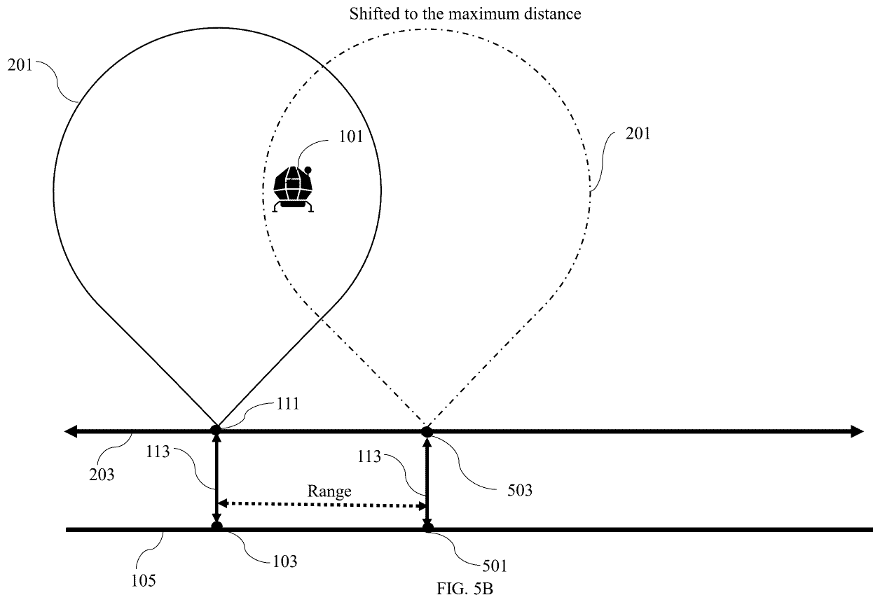

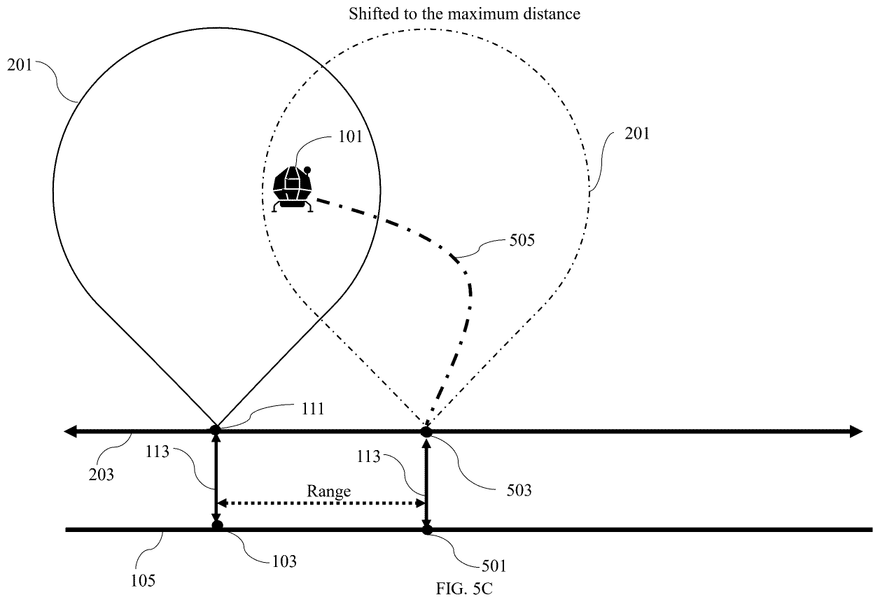

FIG. 5A illustrates shifting of the selected controllable set 201 upon the detection of the hazards, according to some embodiments of the present disclosure. The selected controllable set 201 is at the predetermined distance 113 above the landing location 103 on the landing surface 105. The lander 101 scans for the hazards at the landing location 103. Upon the detection of the hazards at the landing location 103, the motion planner 123 is configured to shift the selected controllable set 201 to a maximum distance along the horizontal axis 203 while maintaining the current state of the lander 101 within the selected controllable set 201. The shifted selected controllable set 201 is also at the predetermined distance 113 above the landing surface 105.

Referring to FIG. 5B, the motion planner 123 is further configured to select a new landing location from a range of landing locations from the list 121a of desired landing locations that lie between the landing location 103 and a location 501 on the landing surface 105 located below a hover point 503 of the selected controllable set 201 shifted to the maximum distance.

Referring to FIG. 5C, the motion planner 123 is further configured to determine a trajectory 505 from the current state of the lander 101 to the hover point 503 of the selected controllable set 201 shifted to the maximum distance along the horizontal axis 203.

The determination of the trajectory 505, the constraints imposed on the powered descent landing, the controllable set, and hazard avoidance at the desired landing location are mathematically described below.

[symbol] , [symbol] ₊, [symbol] ⁿ, [symbol] , denote sets of real numbers, positive real numbers, Euclidean space, and natural numbers, respectively. ith row of matrix M is denoted by [M]ᵢ. Euclidean distance is denoted by ∥⋅∥. A reference frame, Fₓ includes three orthonormal dextral basis vectors {îₓ, ĵₓ, \hat{k}ₓ}, where \hat{⋅} denotes a unit vector. An angular velocity vector of the frame Fₓ with respect to F_{y} is denoted by ω_{x/y}, and ω^{×} denotes a skew-symmetric matrix of ω.

### Lander Dynamics and Measurement Model

Consider a lander in a powered descent phase to the landing surface 105, a non-inertial surface-fixed frame Fₛ, and an inertial frame Fᵢ. The lander 101 is assumed to be rigid and all external forces acting on the lander 101 are modeled as acting on its center of mass. Translation-only dynamics of the lander 101 relative to and resolved in the surface-fixed frame Fₛ, and its mass depletion dynamics, are given by

$$\ddot{r} ( t ) = \frac{{T}_{c} ( t )}{m ( t )} + g - {ω}_{s / i}^{\times } {ω}_{s / i}^{\times } r ( t ) - 2 {ω}_{s / i}^{\times } \dot{r} ( t ) , \qquad ( 1 )$$

$$\dot{m} ( t ) = - ‖ {T}_{c} ( t ) ‖ {g}_{e} {I}_{sp} = - β ‖ {T}_{c} ( t ) ‖ , \qquad ( 2 )$$

where x=[r^{T} \dot{r}^{T}]^{T}∈ [symbol] ⁶ is a translational state of the lander 101, T_{c}∈ [symbol] ³ is a net thrust applied to the lander 101, g∈ [symbol] ³ is a constant gravity vector of the Moon, ω_{s/i} is the Moon's constant angular velocity vector with respect to the inertial frame Fᵢ, m∈ [symbol] ₊ is a mass of the lander 101, gₑ∈ [symbol] ₊ is Earth's standard gravitational acceleration, and Iₛₚ∈ [symbol] ₊ is a specific impulse of the lander's engine.

Uncertainty model: During the powered descent landing, the lander 101 does not have access to its true state, i.e., true location and true velocity. This navigational uncertainty is modeled as noisy state estimates y(t)∈ [symbol] ⁶ such that

$$y ( t ) = x ( t ) + v ( t ) , \qquad ( 3 )$$

where v(t)˜ [symbol] (0,Σᵥ) is an independent and identically distributed Gaussian noise that models the state estimate uncertainty with zero mean and known covariance matrix Σ_{y}∈ [symbol] ^{6×6}.

### PDG Constraints

The lander 101 is limited by the physical and the operational constraints:

$${m}_{d} \leq m ( t ) \leq {m}_{w} , \qquad ( 4 )$$

$${ρ}_{1} \leq ‖ {T}_{c} ( t ) ‖ \leq {ρ}_{2} , \qquad ( 5 )$$

$$‖ {T}_{c} ( t ) ‖ cos ( {θ}_{max} ) \leq {\hat{n}}^{T} {T}_{c} ( t ) , \qquad ( 6 )$$

$$‖ r ( t ) - {r}_{ls} ‖ cos ( γ ) \leq {\hat{k}}_{s}^{T} r ( t ) , \qquad ( 7 )$$

$$‖ \dot{r} ( t ) ‖ \leq {v}_{max} . \qquad ( 8 )$$

Constraint (4) requires that the lander's mass lie between the dry mass m_{d} and the wet mass m_{w}=m_{d}+m_{f}, Constraint (5) requires that the thrust is bounded from above and below with known constants ρ₁, ρ₂. Constraint (6) is an attitude constraint that limits a thrust vector from deviating by more than θₘₐₓ∈[0, π] from a pre-specified direction \hat{n}∈ [symbol] ³, and is often used to either limit a tilt angle of the lander 101 from vertical, or ensure sensor line of sight with the landing location 103. Constraint (7) is a glideslope constraint with glideslope angle γ∈[0, π/2] relative to a landing site (e.g., the landing location 103) rₗₛ∈ [symbol] ³, such that the lander 101 can avoid crashing into nearby terrain. Constraint (8) sets a maximum velocity vₘₐₓ∈ [symbol] .

### Fuel-Optimal PDG Under Navigational Uncertainty

It is an objective of some embodiments to drive the true state of the lander 101 with uncertain initial conditions

$$x ( 0 ) ∼ 𝒩 ( y ( 0 ) , {\sum }_{v} ) , m ( 0 ) = {m}_{w} , \qquad ( 9 )$$

where y(0) is the noisy state estimate at the start of the powered descent, to a convex and compact region χₗₛ⊂ [symbol] ⁶ around the landing site rₗₛ∈ [symbol] ³, such that

$$x ( {t}_{f} ) ∈ {𝒳}_{ls} . \qquad ( 10 )$$

To achieve such an objective, a fuel-optimal powered descent guidance (PDG) optimal control problem (OCP) under navigational uncertainty is formulated as

$${min}_{{t}_{f} , {T}_{c}} ( m ( 0 ) - m ( {t}_{f} ) ) s . t . ∀ t ∈ [ 0 , {t}_{f} ] \qquad ( 11 )$$

$$dynamics ( 1 ) ( 2 ) with initial conditions ( 9 ) ,$$

$$P \{ constraints ( 4 ) - ( 8 ) ( 10 ) are satisfied \} \geq α .$$

απ(0,1] is the user specified probability selected to ensure that the constraints (4)-(8), (10) are met with a likelihood no smaller than α.

It is an object of some embodiments to find a tractable method to solve (11) and to leverage that method to divert to an alternative landing site in case the hazard is detected.

Problem 1 (Nominal trajectory design): Design a tractable optimization formulation of (11) for constraint-admissible PDG under the navigational uncertainty with greater than or equal to the user specified probability.

Problem 2 (Hazard avoidance): If the hazard is detected, identify a reachable, alternative landing site and use a modified version of (11) to divert to the alternative landing site.

To solve Problem 1, (11) reformulated as a convex chance-constrained optimal control problem, given by OCP 1. To solve Problem 2, inner-approximations of the stochastic controllable sets are determined using OCP 2 and OCP 3 that are described below. The stochastic controllable sets enable a real-time assessment of the reachability of alternative landing sites.

### 1. Convex Chance-Constrained PDG

### 1.1 Model Reformulation

Let

$$u ( t ) {=}^{Δ} \frac{{T}_{c} ( t )}{m ( t )} ,$$

then translational dynamics (1) can be written as

$$\dot{x} ( t ) = Ax ( t ) + Bu ( t ) + G , \qquad ( 13 )$$

for appropriate A, B, G matrices. The Gaussian noise v(0) is reformulated as a state disturbance that with probability α lies in an ellipsoid

$${ε}_{α} : \{ v ( 0 ) \vert {v ( 0 )}^{T} {\sum }^{- 1} v ( 0 ) \leq {F}_{{χ}^{2} ( 6 )}^{- 1} ( α ) \} , \qquad ( 14 )$$

that is, P{v(0)∈ε_{α}}=α, where χ²(6) is a chi-squared random variable with six degrees of freedom, and F_{χ}_{²}₍₆₎(⋅) is its cumulative distribution function. Given an estimate y(0), the ellipsoid χ(0)={y(0)}⊕ε_{α} contains all possible true initial states x(0) with probability α by (9). Evolution of possible true trajectories x(t) evolving from χ(0) is given by

$$x ( t ) ∈ 𝒳 ( t ) : \{ x \vert {( \overline{x} ( t ) - x )}^{T} S ( t ) ( \overline{x} ( t ) - x ) \leq 1 \} , \qquad ( 15 )$$

$$S ( t ) = Φ ( 0 , t ) S ( 0 ) {Φ ( 0 , t )}^{T} , S ( 0 ) = \frac{1}{{R}^{2}} {\sum }^{- 1} , \qquad ( 16 )$$

$$\dot{\overline{x}} ( t ) = A \overline{x} ( t ) + Bu ( t ) + G , \overline{x} ( 0 ) = y ( 0 ) , \qquad ( 17 )$$

$$where {R}^{2} = {F}_{{χ}^{2} ( 6 )}^{- 1} ( α ) ,$$

and Φ(0, t) is a state transition matrix for dynamics defined by (13).

### 1.2 Constraint Reformulation

The glideslope and maximum velocity constraints (7), (8) are replaced by conservatively substituting their [symbol] ²-norms with [symbol] ^{∞}/ [symbol] ¹-norms. The resulting affine constraints are written compactly as

$$H ( \overline{x} ( t ) - {x}_{ls} ) \leq f , \qquad ( 18 )$$

where a matrix of normals H∈ [symbol] ^{6×n}^{_{H}} and a vector of facet offsets f∈ [symbol] ⁿ^{_{H}} define a polytopic constraint set. To ensure a tube of possible trajectories χ(t) remains feasible, constraint (18) is tightened:

$$‖ {{S ( t )}^{1 / 2} [ H ]}_{i} ‖ \leq - {[ H ]}_{i} ( \overline{x} ( t ) - {x}_{ls} ) + {[ f ]}_{i} i = 1 , … , {n}_{H} . \qquad ( 19 )$$

Additionally, (10) is replaced with

$$\overline{x} ( {t}_{f} ) = {\overline{x}}_{{t}_{f}}^{*} , \qquad ( 20 )$$

$$where : {\overline{x}}_{{t}_{f}}^{*} = arg {{min}_{{\overline{x}}_{{t}_{f}}} ( {\overline{x}}_{{t}_{f}} - {x}_{ls} )}^{T} ( {\overline{x}}_{{t}_{f}} - {x}_{ls} ) , \qquad ( 21 )$$

$$s . t . ‖ {{S ( {t}_{f} )}^{1 / 2} [ H ]}_{i} ‖ \leq - {[ H ]}_{i} ( {\overline{x}}_{{t}_{f}} - {x}_{ls} ) + {[ f ]}_{i} . \qquad ( 22 )$$

Problem (21), (22) finds a closest possible final state x̅(tr) to the desired landing location xₗₛ such that a set of possible true states χ(t_{f}) fits in the polytope (19).

### 1.3 Lossless Convexification

Further, substituting (16), (17) for (1), (19) for (7), (8), and (20) for (10), the OCP in (11) can be transformed into a convex problem using lossless convexification techniques. Dynamics (2) and constraints (4), (5), (6) become

$$\dot{z} = - βσ ( t ) 6 cm \qquad ( 23 )$$

$${z}^{0} ( t ) \leq z ( t ) \leq ln ( {m}_{w} - {βρ}_{1} t ) , \qquad ( 24 )$$

$$z ( 0 ) = ln ( {m}_{w} ) , ln ( {m}_{d} ) \leq z ( {t}_{f} ) ,$$

$${ρ}_{1} {e}^{- {z}^{0} ( t )} [ 1 - ( z ( t ) - {z}^{0} ( t ) ) + \frac{{( z ( t ) - {z}^{0} ( t ) )}^{2}}{2} ] \leq σ ( t ) , \qquad ( 25 )$$

$$σ ( t ) \leq {ρ}_{2} {e}^{- {z}^{0} ( t )} [ 1 - ( z ( t ) - {z}^{0} ( t ) ) ] , \qquad ( 26 )$$

$${\hat{n}}^{T} u ( t ) \geq σ ( t ) cos ( {θ}_{max} ) , \qquad ( 27 )$$

$$‖ u ( t ) ‖ \leq σ ( t ) , \qquad ( 28 )$$

where z(t)≙ ln(m(t)), z⁰(t)=ln(m_{w}−βρ₂t), and σ(t) is a slack variable used in the convexification. With these substitutions, OCP 1 is formulated as

$OCP 1: {max}_{u , σ , {t}_{f}} z ( {t}_{f} )$
subject to ∀t ∈ [0, t_{f}]
dynamics (16), (17), (23),
constraints (19), (20), (24) - (28).

OCP 1 is a tractable chance-constrained formulation of (11) and solves Problem 1.

### 2. Divert-Feasible Sets

During the powered descent landing, the lander 101 scan the lander 101 for hazards and produce candidate landing sites. If the hazard is detected at a nominal landing site rₗₛ, the lander 101 needs to identify which alternatives are reachable. Since solving OCP 1 to each candidate site may be too computationally intensive, a database of stochastic controllable sets parameterized by mass

$${m}_{w}^{s} ∈ [ {m}_{d} , {m}_{w} ]$$

are determined offline. The stochastic controllable sets characterize the set of noisy state estimates from which the lander can be driven to a specified landing site with the user specified probability. Online, the current state estimate of the lander 101 is checked for inclusion against the database of stochastic controllable sets at the candidate landing sites. The inclusion check amounts to either evaluating linear inequalities if a halfspace representation of the stochastic controllable set is known or a linear program in case of a vertex representation. Further, a feasible set is defined based on convexified dynamics (13), (23), and constraints (18), (24)-(28), in absence of the navigational uncertainty

$$Feas ( {m}_{w}^{s} ) {=}^{Δ} \{ \begin{matrix}∃ {t}_{f} \geq 0 s . t . ∀ t ∈ [ 0 , {t}_{f} ] , \\ ( x ( 0 ) , u ) \vert ( x ( t ) , u ( t ) ) satisfies \\ ( 13 ) , ( 18 ) , ( 23 ) , ( 24 ) - ( 28 )\end{matrix} \} . \qquad ( 29 )$$

In presence of the navigational uncertainty, the stochastic controllable set is defined as a set-valued function of

$${m}_{w}^{s} \qquad ( 30 )$$

$$𝒞 ( {m}_{w}^{s} ) {=}^{Δ} \{ y ( 0 ) : ∃ u s . t . {P}_{v ( 0 )} \{ ( y ( 0 ) - v ( 0 ) , u ) ∈ Feas ( {m}_{w}^{s} ) \} \geq α \} ,$$

with xₗₛ=0, which, for a given

$${m}_{w}^{s} ,$$

is a set of all initial state estimates y(0) for which there exists a constraint-admissible control sequence that drives the lander 101 to origin with at least probability α. Note that with xₗₛ=0, constraints in (30) are, and thus the stochastic controllable set [symbol] is, invariant under translation.

Further, inner approximation of each set [symbol] is constructed in several stages. First, a set of convex programs is formulated

OCP2: For i = 1, .... , 12
${{Max}_{\overline{x} ( 0 ) , u , {t}_{f}} [ {[ {\overline{x} ( 0 )}^{⊤} , - {\overline{x} ( 0 )}^{⊤} ]}^{⊤} ]}_{i}$
subject to f or ∀t ∈ [0, t_{f}]
dynamics (16), (17), (23),
constraints (19), (20), (24) - (28).

OCP2 finds extreme points x̅(0)∈ [symbol] for which a corresponding ellipsoidal set of possible true initial states χ(0) can be driven to the origin. Convex hull of resulting twelve x̅(0) points [symbol] is taken as initial approximation of [symbol] . In the next step, the stochastic controllable sets are enlarged by finding an outward normal \hat{n}_{facet,i} to each of polytope facets and finding a furthest point x̅ (0) from the facet for which all points in the ellipsoidal corresponding set χ(0) remain as feasible initial conditions. This procedure is achieved by solving

OCP3: For i = 1, ... , n_{facets}
${Max}_{\overline{x} ( 0 ) , u , {t}_{f}} {\hat{n}}_{facet , i}^{⊤} \overline{x} ( 0 )$
subject to f or ∀t ∈ [0, t_{f}]
dynamics (17), (23),
constraints (19), (20), (24) - (28).

In OCP 3, n_{facets} is a number of facets of [symbol] . The resulting points [symbol] are added to a set of vertices of [symbol] , and the convex hull is updated. The resulting polytope [symbol] can again be enlarged in the same way, facet by facet. This iteration is terminated based on available computational resources or a tolerance on a volume difference between [symbol] and an an outer approximation. Final [symbol] thus approximates the [symbol] set.

### 3. Feasibility and Safety Guarantees

### 3.1 Stochastic Controllable Sets

Using (14), (15)-(17), a tractable alternative set can be defined as

$$( {m}_{w}^{s} ) {=}^{Δ} \{ y ( 0 ) : ∃ u for ∀ v ( 0 ) ∈ {ε}_{α} s . t ( y ( 0 ) - v ( 0 ) , u ) ∈ Feas ( {m}_{w}^{s} ) \} . \qquad ( 31 )$$

Lemma 1:

$$( {m}_{w}^{s} ) ⊆ ( {m}_{w}^{s} )$$

Proof: Let y∈ [symbol] . From (14), (15)-(17) and (31) it follows

$$P \{ ( y ( 0 ) - v ( 0 ) , u ) ∈ Feas ( {m}_{w}^{s} ) \vert v ( 0 ) ∈ {ε}_{α} \} = 1. \qquad ( 32 )$$

Consequently,

$${P}_{v ( 0 )} \{ ( y ( 0 ) - v ( 0 ) , u ) ∈ Feas ( {m}_{w}^{s} ) \} \geq {P}_{v ( 0 )} \{ ( y ( 0 ) - v ( 0 ) , u ) ∈ Feas ( {m}_{w}^{s} ) \} ⋂ \{ v ( 0 ) ∈ {ε}_{α} \} \} = P \{ ( y ( 0 ) - v ( 0 ) , u ) ∈ Feas ( {m}_{w}^{s} ) \vert v ( 0 ) ∈ {ε}_{α} \} P \{ v ( 0 ) ∈ {ε}_{α} \} = α . \qquad ( 33 )$$

Thus from (30), y(0)∈ [symbol] .
Lemma 2: Let

$$( {u}^{*} , {σ}^{*} , {t}_{f}^{*} )$$

be a solution of Our 2 (UCP 3) for a given m_{w} and an initial state estimate y(0)∈ [symbol] . Then, at all temporal nodes, a trajectory starting from any point x₀∈χ(0) under a trajectory u* satisfies constraints forming the feas

$$( {m}_{w}^{s} ) ,$$

$$( {x}_{0} , {u}^{*} ) ∈ Feas ( {m}_{w}^{s} ) ∀ {x}_{0} ∈ 𝒳 ( 0 ) .$$

Proof: The tightened constraint (19) can be generalized at all discrete temporal nodes as

$${[ H ]}_{i} {\overline{x}}_{k} + {Support}_{Reach ( k , {ε}_{α} )} ) ( {[ H ]}_{i} ) \leq {[ f ]}_{i} , \qquad ( 34 )$$

$$for i = 1 , … , {n}_{H} where {Support}_{R} ( l ) = {max}_{ζ ∈ R} {l}^{T} ζ and$$

$$Reach ( k , {ε}_{α} ) = \{ {\prod }_{t = 0}^{k - 1} {A}_{d}^{t} v ( 0 ) \vert v ( 0 ) ∈ {ε}_{α} \} .$$

From superposition principle, due to linearity of (13), x(t)=x̅(t)+v(t), where v(t)∈Φ(0, t)ε_{α}. Similarly, at the temporal nodes, xₖ=x̅ₖ+vₖ, where vₖ∈Reach(k, ε_{α}). Thus, from the tightening of the constraints (34), it follows that Hxₖ≤f.

Corollary 1: Lemma 2 holds for a given landing location xₗₛ. Due to the assumption that the constraints (19), (24)-(28) are invariant with respect to translation, the sets can be translated to new landing locations without loss of safety guarantees when landing at the alternative landing site.

Theorem 1: [symbol] is an inner-approximation to [symbol] .

Proof: Let qᵢ be i-th vertex of [symbol] . From Lemma 2 it follows that

$$( \{ {q}_{i} \} ⊕ {ε}_{α} , u ) ⊆ Feas ( {m}_{w}^{s} )$$

thus qᵢ∈ [symbol] . Given that [symbol] is the convex hull of {qᵢ} and [symbol] is also convex, it follows [symbol] ⊆ [symbol] and from Lemma 1 it follows that [symbol] ⊆ [symbol] .

Theorem 2: [symbol] is an inner approximation for a stochastic controllable set defined using the feasibility set (29) with the nonlinear dynamics and constraints (2), (4)-(8) replacing (23), (24)-(28).

Proof: The proof follows from Theorem 1, convexity of the sets [symbol] and the fact that each of the vertices of these sets, computed using OCP 2 or 3, is guaranteed to be reachable for the original nonlinear dynamics.

### 3.2 Stochastic Trajectory Optimization

Lemma 3 Let (u*, σ*, t*_{f}) be a solution of OCP 1 for a given m_{w} and an initial state measurement y₀∈ [symbol] . Then at all temporal nodes, the trajectory starting from any point x₀∈{y(0)}⊕ε_{α} under the trajectory u* satisfies the constraints of OCP 1, 2, and 3, i.e.

$$P \{ ( {x}_{0} , {u}^{*} ) ∈ Feas ( {m}_{w}^{s} ) \} = 1 ,$$

For a general v(0) from the Gaussian distribution and the corresponding true state x₀=y₀+v₀ it holds that

$$P \{ ( {x}_{0} , {u}^{*} ) ∈ Feas ( {m}_{w}^{s} ) \} \geq α . \qquad ( 35 )$$

Proof. The proof is analogous to the proof of Lemma 1 and (35) follows from Equation (33). In other words, the trajectory u* obtained using OCP 1 drives all trajectories started from the ellipsoid of possible initial true states X₀={y(0)}⊕ε_{α} to the landing location safely without violating any constraints. Because P(v(0)∈ε_{α})=α, it follows that for the general v(0) from the Gaussian distribution, and its associated true state x(0), landing is achieved without violating the constraints with the user specified probability of α or higher.

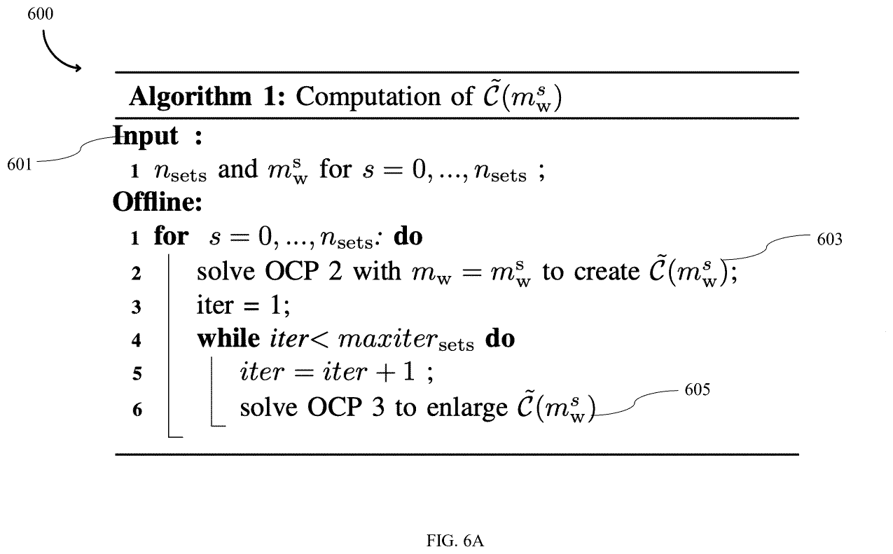

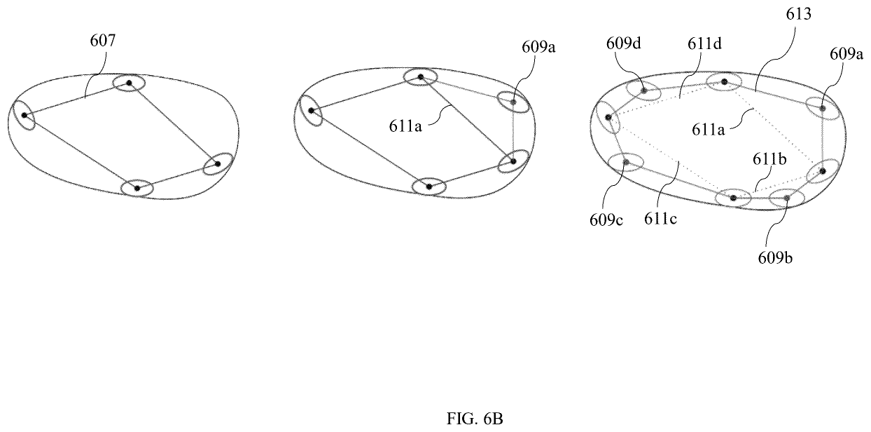

FIG. 6A illustrates an algorithm for determining the stochastic controllable set [symbol] according to an embodiment of the present disclosure. FIG. 6B shows a schematic of computation of the stochastic controllable set [symbol] , according to an embodiment of the present disclosure. FIG. 6A and FIG. 6B are explained in conjunction with each other.

Inputs 601 to the algorithm 600 are a number of facets of [symbol] , n_{facets}, and a mass of the lander,

$${m}_{w}^{s} .$$

At step 603, the algorithm 600 includes solving the OCP2 to create an initial stochastic controllable set. 607 represents an example of initial stochastic controllable set.

At step 603, the algorithm 600 includes solving the OCP3 to enlarge the initial stochastic controllable set 607. For instance, the initial stochastic controllable set 607 is enlarged by determining a furthest point 609a from a facet 611a for which all points in the ellipsoidal corresponding set χ(0) remain as the feasible initial conditions. Likewise, furthest points 609b, 609c, 609d are determined corresponding to facets 611b, 611c, 611d, respectively, to obtain a stochastic controllable set [symbol] 613. The step 603 is executed iteratively until a termination condition is met. The termination condition, for example, is a maximum number of iterations maxiterₛₑₜₛ.

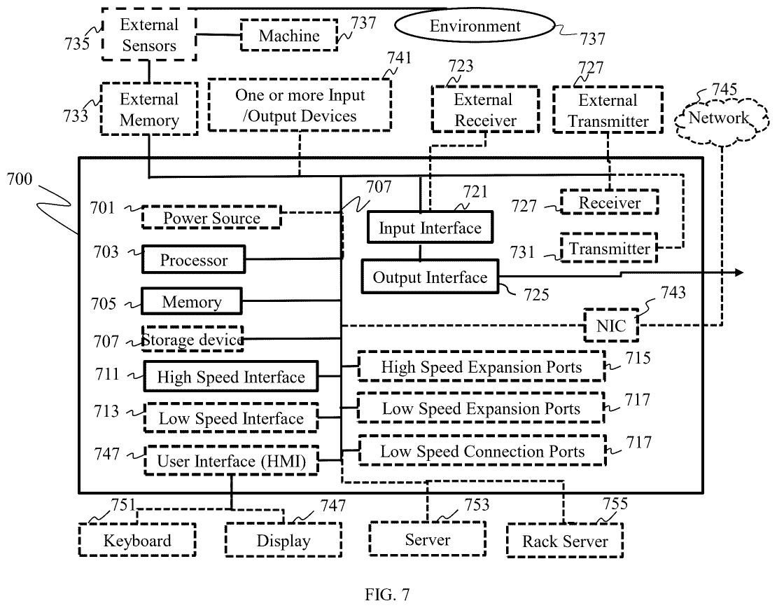

FIG. 7 is a schematic illustrating by non-limiting example a computing apparatus for implementing the methods and the systems of the present disclosure. The computing device 700 can include a power source 701, a processor 703, a memory 705, a storage device 707, all connected to a bus 709. Further, a high-speed interface 711, a low-speed interface 713, high-speed expansion ports 715 and low speed connection ports 717, can be connected to the bus 709. In addition, a low-speed expansion port 719 is in connection with the bus 709. Further, an input interface 721 can be connected via the bus 709 to an external receiver 723 and an output interface 725. A receiver 727 can be connected to an external transmitter 729 and a transmitter 731 via the bus 709. Also connected to the bus 709 can be an external memory 733, external sensors 735, machine(s) 737, and an environment 739. Further, one or more external input/output devices 741 can be connected to the bus 709. A network interface controller (NIC) 743 can be adapted to connect through the bus 709 to a network 745, wherein data or other data, among other things, can be rendered on a third-party display device, third party imaging device, and/or third-party printing device outside of the computer device 700.

The memory 705 can store instructions that are executable by the computer device 700, historical data, and any data that can be utilized by the methods and systems of the present disclosure. The memory 705 can include random access memory (RAM), read only memory (ROM), flash memory, or any other suitable memory systems. The memory 705 can be a volatile memory unit or units, and/or a non-volatile memory unit or units. The memory 705 may also be another form of computer-readable medium, such as a magnetic or optical disk.

The storage device 707 can be adapted to store supplementary data and/or software modules used by the computer device 700. For example, the storage device 707 can store historical data and other related data as mentioned above regarding the present disclosure. Additionally, or alternatively, the storage device 707 can store historical data like data as mentioned above regarding the present disclosure. The storage device 707 can include a hard drive, an optical drive, a thumb-drive, an array of drives, or any combinations thereof. Further, the storage device 707 can contain a computer-readable medium, such as a floppy disk device, a hard disk device, an optical disk device, or a tape device, a flash memory or other similar solid-state memory device, or an array of devices, including devices in a storage area network or other configurations. Instructions can be stored in an information carrier. The instructions, when executed by one or more processing devices (for example, the processor 703), perform one or more methods, such as those described above.

The computing device 700 can be linked through the bus 709, optionally, to a display interface or user Interface (HMI) 747 adapted to connect the computing device 700 to a display device 749 and a keyboard 751, wherein the display device 749 can include a computer monitor, camera, television, projector, or mobile device, among others. In some implementations, the computer device 700 may include a printer interface to connect to a printing device, wherein the printing device can include a liquid inkjet printer, solid ink printer, large-scale commercial printer, thermal printer, UV printer, or dye-sublimation printer, among others.

The high-speed interface 711 manages bandwidth-intensive operations for the computing device 700, while the low-speed interface 713 manages lower bandwidth-intensive operations. Such allocation of functions is an example only. In some implementations, the high-speed interface 711 can be coupled to the memory 705, the user interface (HMI) 747, and to the keyboard 751 and the display 749 (e.g., through a graphics processor or accelerator), and to the high-speed expansion ports 715, which may accept various expansion cards via the bus 709. In an implementation, the low-speed interface 713 is coupled to the storage device 707 and the low-speed expansion ports 717, via the bus 709. The low-speed expansion ports 717, which may include various communication ports (e.g., USB, Bluetooth, Ethernet, wireless Ethernet) may be coupled to the one or more input/output devices 741. The computing device 700 may be connected to a server 753 and a rack server 755. The computing device 700 may be implemented in several different forms. For example, the computing device 700 may be implemented as part of the rack server 755.

The description provides exemplary embodiments only, and is not intended to limit the scope, applicability, or configuration of the disclosure. Rather, the following description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the following description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like reference numbers and designations in the various drawings indicated like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed, but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine. Typically, the functionality of the program modules may be combined or distributed as desired in various embodiments.

Embodiments of the present disclosure may be embodied as a method, of which an example has been provided. The acts performed as part of the method may be ordered in any suitable way. Accordingly, embodiments may be constructed in which acts are performed in an order different than illustrated, which may include performing some acts concurrently, even though shown as sequential acts in illustrative embodiments.

Further, embodiments of the present disclosure and the functional operations described in this specification can be implemented in digital electronic circuitry, in tangibly-embodied computer software or firmware, in computer hardware, including the structures disclosed in this specification and their structural equivalents, or in combinations of one or more of them. Further some embodiments of the present disclosure can be implemented as one or more computer programs, i.e., one or more modules of computer program instructions encoded on a tangible non transitory program carrier for execution by, or to control the operation of, data processing apparatus. Further still, program instructions can be encoded on an artificially generated propagated signal, e.g., a machine-generated electrical, optical, or electromagnetic signal, which is generated to encode information for transmission to suitable receiver apparatus for execution by a data processing apparatus. The computer storage medium can be a machine-readable storage device, a machine-readable storage substrate, a random or serial access memory device, or a combination of one or more of them.

According to embodiments of the present disclosure the term “data processing apparatus” can encompass all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code.

A computer program can be deployed to be executed on one computer or on multiple computers that are located at one site or distributed across multiple sites and interconnected by a communication network. Computers suitable for the execution of a computer program include, by way of example, can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data.

Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

Although the present disclosure has been described with reference to certain preferred embodiments, it is to be understood that various other adaptations and modifications can be made within the spirit and scope of the present disclosure. Therefore, it is the aspect of the append claims to cover all such variations and modifications as come within the true spirit and scope of the present disclosure.

We claim:

1. A lander configured for powered descent landing with uncertainty in a current state of the lander, the lander comprising:
a memory configured to store a list of desired landing locations on a landing surface, and a plurality of controllable sets determined for different amounts of fuel remaining in the lander and a desired time of descent to the landing surface, wherein each controllable set is a polytope defining a volume of states of the lander symmetric around a vertical axis perpendicular to the landing surface with a hover point located on the vertical axis at a predetermined distance above the landing surface as a vertex, and wherein each state includes a location and a velocity of the lander;
a motion planner configured to (1) select a controllable set from the plurality of controllable sets based on a current amount of fuel remaining in the lander and the desired time of descent; (2) shift the selected controllable set along a horizontal axis to place the hover point above a landing location selected from the list of desired landing locations; (3) check if a current state of the lander lies within the selected controllable set, and generate a trajectory from the current state of the lander to the hover point of the shifted controllable set; else (4) select another landing location from the list of desired landing location; and
a controller configured to control the lander according to the trajectory to navigate the lander to the hover point.

2. The lander of claim 1, wherein the predetermined distance of the hover point above the landing surface is a function of stochastic guarantees of a chance constraint imposed on the powered descent landing.

3. The lander of claim 1, wherein each of the plurality of controllable sets is a stochastic controllable set, and wherein the stochastic controllable set is a set of current state estimates of the lander from which the lander is drivable to a hover point associated with the stochastic controllable set with a user specified probability for a given amount of remaining fuel and the desired time of descent.

4. The lander of claim 3, wherein the hover point of the stochastic controllable set is a center of an ellipsoid, and wherein the ellipsoid is a function of the stochastic guarantees of a chance constraint imposed on the powered descent landing, and the center of the ellipsoid is a closest point to the landing location on the landing surface such that the ellipsoid is entirely contained within an area defined state constraints.

5. The lander of claim 1, wherein the motion planner is further configured to:
determine multiple shifted copies of the selected controllable set to place a hover point of each of the multiple shifted copies of the selected controllable set above different landing locations of the list of desired landing locations, and maintain the current state of the lander within an intersection of the multiple shifted copies of the selected controllable set; and
determine a trajectory from the current state of the lander to a hover point of a shifted copy of the selected controllable set located above a desired landing location selected from the different landing locations, while prioritizing maintaining the trajectory within an intersection of two or more shifted copies of the multiple shifted copies of the selected controllable set.

6. The lander of claim 5, wherein the motion planner is further configured to change, upon a hazard detection at the desired landing location, from the desired landing location below the hover point of the shifted copy of the selected controllable set to a landing location below a hover point of a different shifted copy of the multiple shifted copies.

7. The lander of claim 1, wherein the motion planner is further configured to shift, upon a hazard detection at the landing location, the selected controllable set to a maximum distance along the horizontal axis while maintaining the current state of the lander within the selected controllable set.

8. The lander of claim 7, the motion planner is further configured to select a new landing location from a range of landing locations between the landing location and a location on the landing surface below a hover point of the selected controllable set shifted to the maximum distance along the horizontal axis.

9. The lander of claim 8, the motion planner is further configured to determine a trajectory from the current state of the lander to the hover point of the selected controllable set shifted to the maximum distance along the horizontal axis.

10. The lander of claim 3, wherein the stochastic controllable set is determined by enlarging an initial stochastic controllable set by determining a furthest point correspond to each facet of the initial stochastic controllable set, and wherein initial stochastic controllable set is determined by solving an optimal control problem.

11. The lander of claim 1, wherein the lander is a spacecraft and the landing surface is a surface of moon.

12. A method for performing powered descent landing with uncertainty in a current state of a lander, the method uses a memory configured to store a list of desired landing locations on a landing surface, and a plurality of controllable sets determined for different amounts of fuel remaining in the lander and a desired time of descent to the landing surface, wherein each controllable set is a polytope defining a volume of states of the lander symmetric around a vertical axis perpendicular to the landing surface with a hover point located on the vertical axis at a predetermined distance above the landing surface as a vertex, and wherein each state includes a location and a velocity of the lander, the method comprising:
selecting a controllable set from the plurality of controllable sets based on a current amount of fuel remaining in the lander and the desired time of descent;
shifting the selected controllable set along a horizontal axis to place the hover point above a landing location selected from the list of desired landing locations;
checking if a current state of the lander lies within the selected controllable set;
generating a trajectory from the current state of the lander to the hover point of the shifted controllable set if the current state of the lander lies within the selected controllable set; and
controlling the lander according to the trajectory to navigate the lander to the hover point.

13. The method of claim 12, wherein the predetermined distance of the hover point above the landing surface is a function of stochastic guarantees of a chance constraint imposed on the powered descent landing.

14. The method of claim 12, wherein each of the plurality of controllable sets is a stochastic controllable set, and wherein the stochastic controllable set is a set of current state estimates of the lander from which the lander is drivable to a hover point associated with the stochastic controllable set with a user specified probability for a given amount of remaining fuel and the desired time of descent.

15. The method of claim 14, wherein the hover point of the stochastic controllable set is a center of an ellipsoid, and wherein the ellipsoid is a function of the stochastic guarantees of a chance constraint imposed on the powered descent landing, and the center of the ellipsoid is a closest point to the landing location on the landing surface.

16. The method of claim 12, wherein the method further comprises:
determining multiple shifted copies of the selected controllable set to place a hover point of each of the multiple shifted copies of the selected controllable set above different landing locations of the list of desired landing locations, and maintaining the current state of the lander within an intersection of the multiple shifted copies of the selected controllable set; and
determining a trajectory from the current state of the lander to a hover point of a shifted copy of the selected controllable set located above a desired landing location selected from the different landing locations, while prioritizing maintaining the trajectory within an intersection of two or more shifted copies of the multiple shifted copies of the selected controllable set.

17. The method of claim 16, wherein the method further comprises changing, upon a hazard detection at the desired landing location, from the desired landing location below the hover point of the shifted copy of the selected controllable set to a landing location below a hover point of a different shifted copy of the multiple shifted copies.

18. A non-transitory computer readable storage medium embodied thereon a program executable by a processor for performing a method for performing powered descent landing with uncertainty in a current state of a lander, the storage medium stores a list of desired landing locations on a landing surface, and a plurality of controllable sets determined for different amounts of fuel remaining in the lander and a desired time of descent to the landing surface, wherein each controllable set is a polytope defining a volume of states of the lander symmetric around a vertical axis perpendicular to the landing surface with a hover point located on the vertical axis at a predetermined distance above the landing surface as a vertex, and wherein each state includes a location and a velocity of the lander, the method comprising:
selecting a controllable set from the plurality of controllable sets based on a current amount of fuel remaining in the lander and the desired time of descent;
shifting the selected controllable set along a horizontal axis to place the hover point above a landing location selected from the list of desired landing locations;
checking if a current state of the lander lies within the selected controllable set;
generating a trajectory from the current state of the lander to the hover point of the shifted controllable set if the current state of the lander lies within the selected controllable set; and
controlling the lander according to the trajectory to navigate the lander to the hover point.

19. The non-transitory computer readable storage medium of claim 18, wherein the predetermined distance of the hover point above the landing surface is a function of stochastic guarantees of a chance constraint imposed on the powered descent landing.

20. The non-transitory computer readable storage medium of claim 18, wherein each of the plurality of controllable sets is a stochastic controllable set, and wherein the stochastic controllable set is a set of current state estimates of the lander from which the lander is drivable to a hover point associated with the stochastic controllable set with a user specified probability for a given amount of remaining fuel and the desired time of descent.
